(19) United States
(12) Patent Application Publication
(10) Pub. No.: US 2014/0143082 A1
(43) Pub. Date: May 22, 2014

(54) METHOD AND APPARATUS FOR GENERATING CUSTOMIZED DESIGNS FOR RETAIL ITEMS

(71) Applicant: E RETAILING ASSOCIATES LLC, Columbus, OH (US)

(72) Inventor: Benjamin E. LARSON, Columbus, OH (US)

(73) Assignee: E RETAILING ASSOCIATES LLC, Columbus, OH (US)

(21) Appl. No.: 13/682,231

(22) Filed: Nov. 20, 2012

(51) Int. Cl. G06Q 30/06

(52) U.S. Cl. CPC G06Q 30/0621
USPC 705/26.5

(57) ABSTRACT

A method and system is configured to receive information specifying an entity. The system is configured to generate at least one customized design for a retail item based on a template design and the received information. The template design comprises at least one element that is configured to be modified based on the received information, and the at least one element is one of a text object, image object, or color that is modified to correspond to text, an image, or a color associated with the specified entity. The system is configured to transmit the at least one customized design.

### BACKGROUND

1. Field

One embodiment is directed generally to a computer system, and in particular to a computer system that generates customized designs for retail items.

2. Description of Related Art

Retail operations involve the transactions of goods and services from a retailer (seller) to a buyer. Retailers often supply their goods and services to corresponding buyers through integrated supply-chain systems. Retailers may first purchase goods in bulk from a producer of the goods and then subsequently sell smaller quantities of the goods to a buyer for a profit. Although retail transactions have traditionally been performed at specific physical locations, conducting retail transactions over the Internet (i.e., electronic commerce) has become immensely popular. Electronic commerce allows buyers to purchase goods, such as apparel, from a retailer over the Internet.

### SUMMARY

One embodiment is a method and system configured to receive information specifying an entity. The system is configured to generate at least one customized design for a retail item based on a template design and the received information. The template design comprises at least one element that is configured to be modified based on the received information, and the at least one element is one of a text object, image object, or color that is modified to correspond to text, an image, or a color associated with the specified entity. The system is configured to transmit the at least one customized design.

### BRIEF DESCRIPTION OF THE DRAWINGS

FIG. 1 is an overview block diagram of a computer server/system for generating customized designs for retail items in accordance with an embodiment of the present invention.

FIG. 2 is an overview block diagram of an example of a customized design generating system in accordance with one embodiment.

FIG. 3 is a screen shot of an interface for creating a template design in accordance with one embodiment.

FIG. 4 is a screen shot of an interface for configuring elements of a template design in accordance with one embodiment.

FIG. 5 illustrates examples of retail items with customized designs in accordance with one embodiment.

FIG. 6 is a screen shot of an interface 600 for entering information to receive retail items with customized designs in accordance with one embodiment.

FIG. 7 is a screen shot of an interface for specifying how to dynamically generate customized designs for retail items in accordance with one embodiment.

FIG. 8 is a screen shot of an interface for further specifying how to dynamically generate customized designs for retail items in accordance with one embodiment.

FIG. 9A is a screen shot of an interface for receiving customized designs for retail items based upon provided information in accordance with one embodiment.

FIG. 9B is a screen shot of an interface for receiving customized designs for additional retail items based upon provided information in accordance with one embodiment.

FIG. 10 is a flow diagram of the functionality of the customized design generating module of FIG. 1 in accordance with one embodiment.

### DETAILED DESCRIPTION

One embodiment is a system for generating customized designs for retail items. The system may dynamically generate customized designs for retail items based upon a template design and provided information. As such, because thousands of customized designs may be generated from each template design, certain embodiments provide users with a wider selection of customized designs for retail items.

In previous methods of providing designs for retail items to a user, a retailer would show previously-prepared pictures illustrating a set of predetermined designs, with each picture showing a single predetermined design. As such, using the previous methods, in order to show 50 different shirt designs, for example, a retailer would necessarily need to have previously prepared 50 separate pictures, with each picture showing one predetermined design of the 50 different shirt designs. Retailers would be limited in the number of designs they could provide on their sites because, to introduce a new design, the retailer would necessarily need to have previously prepared a picture corresponding to the new design.

In contrast with the previous approaches, one difference between an embodiment of the present system for generating customized designs for retail items when compared to the known systems is that designs for retail items (and corresponding pictures showing the designs) may be dynamically generated based upon a template design in conjunction with provided information (e.g., information provided by a user). Therefore, certain embodiments allow retailers to provide customized designs for retail items without requiring the retailers to previously prepare individual pictures corresponding to each specific customized design. In certain embodiments, the pictures corresponding to these customized designs are dynamically generated at the time a user browses for the customized designs. As such, certain embodiments of the invention are able to provide a vast number of customized designs that may be prohibitively expensive to provide (in terms of time and labor) when using the previous approaches.

In view of the above, certain embodiments may provide users with the ability to browse custom retail items that feature designs pertinent to any one of over 100,000 schools stored within a database. On a webpage corresponding to a given school, a user can find hundreds of retail items that feature designs that incorporate the school's name, mascot, mascot name, and school colors, for example. Each user may be presented with a storefront of retail items that appear to have been specifically created for the school that each user is specifically interested in.

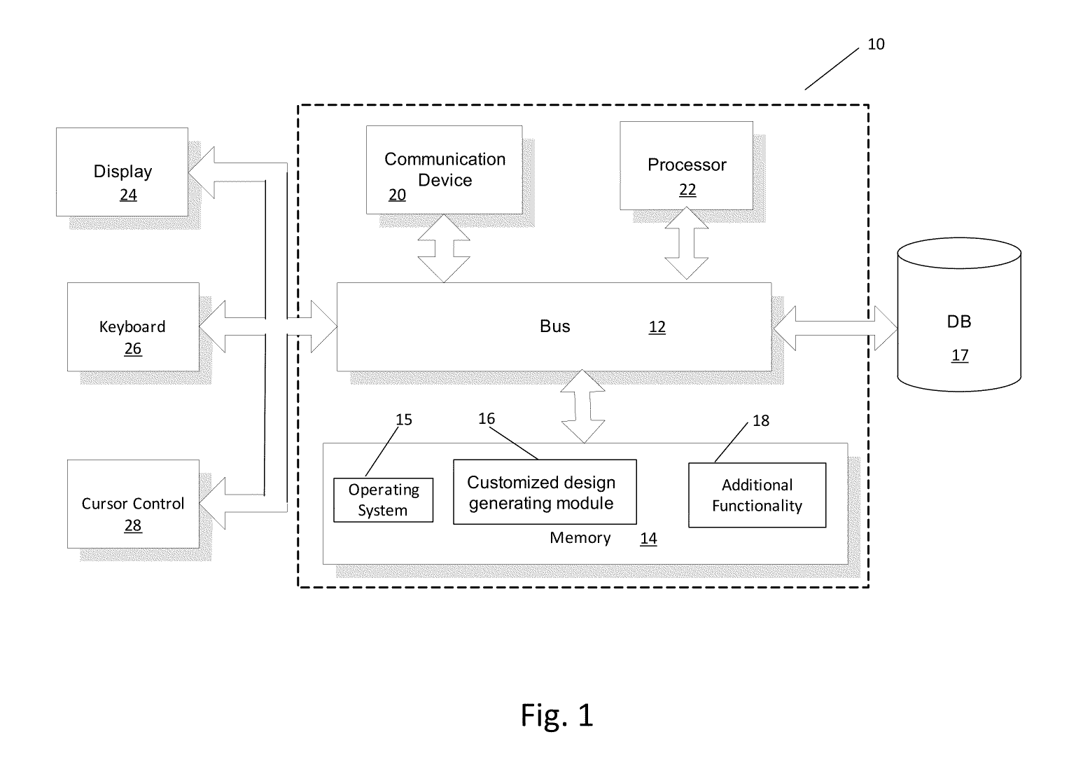

FIG. 1 is an overview block diagram of a computer server/system 10 for generating customized designs for retail items in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 may be further coupled via bus 12 to a display 24, such as a Liquid Crystal Display (“LCD”). A keyboard 26 and a cursor control device 28, such as a computer mouse, may be further coupled to bus 12 to enable a user to interface with system 10.

In one embodiment, memory 14 stores software modules that provide functionality when executed by processor 22. The modules include an operating system 15 that provides operating system functionality for system 10. The modules further include customized design generating module 16 that allows a user to generate customized designs for retail items, as disclosed in more detail below. System 10 can be part of a larger system. Therefore, system 10 will typically include one or more additional functional modules 18 to include the additional functionality, such as data processing functionality for receiving and processing information for generating customized designs for retail items. A database 17 is coupled to bus 12 to store data used with modules 16 and 18. Specifically, database 17 may store data that is later used for generating customized designs by the customized design generating module 16.

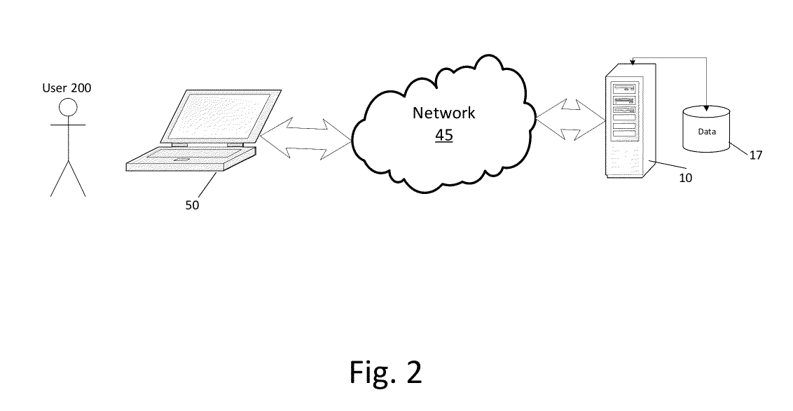

FIG. 2 is an overview block diagram of an example of a customized design generating system in accordance with embodiments of the present invention. In FIG. 2, a user 200 interfaces with server 10 via a computer 50 and a network 45. Network 45 can by any type of communication network, such as the Internet or an Intranet or other private network. Computer 50 can be any type of device that allows user 200 to interface with server 10, including a laptop computer, smart phone, tablet, etc., using a wired or wireless connection, or any other method. Further, in other embodiments, user 200 can interface directly with server 10 (i.e., not via a network) as discussed in conjunction with FIG. 1.

In one embodiment, user 200, using an Internet browser on computer 50, interfaces with an electronic commerce (“e-commerce”) web page/site hosted by server 10, or some other web server coupled to server 10. The e-commerce web page allows user 200 to browse, purchase, view, etc., various retail items with customized designs displayed on the web page.

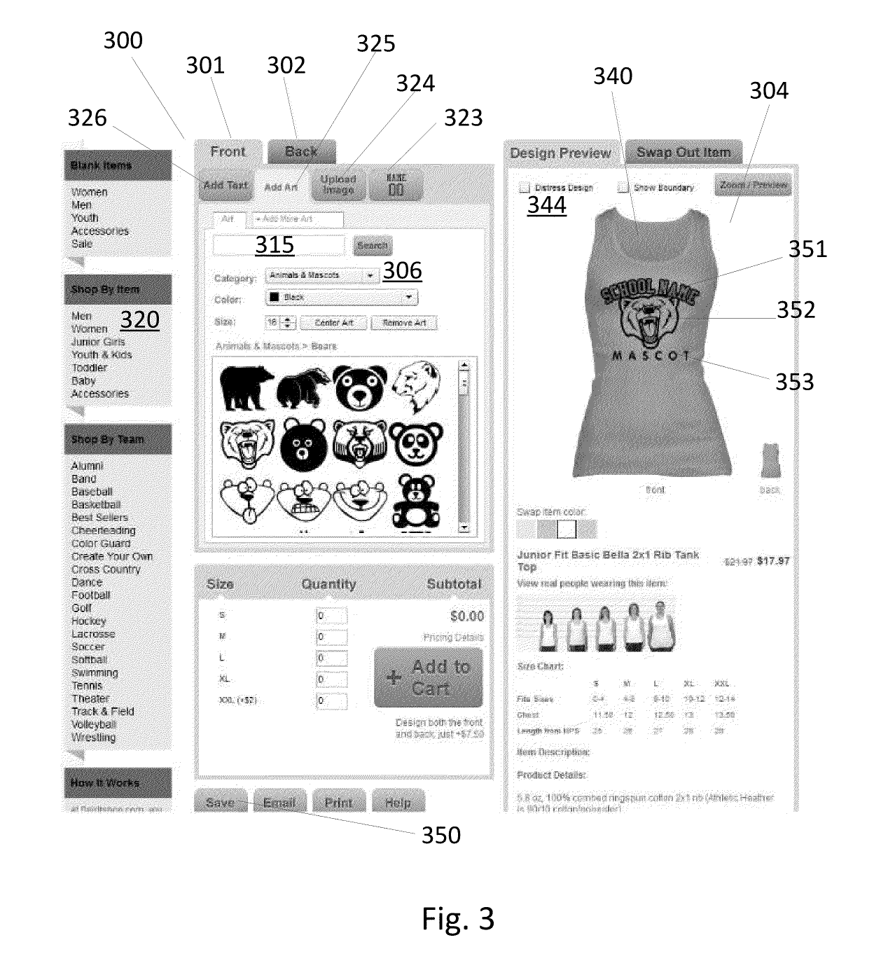

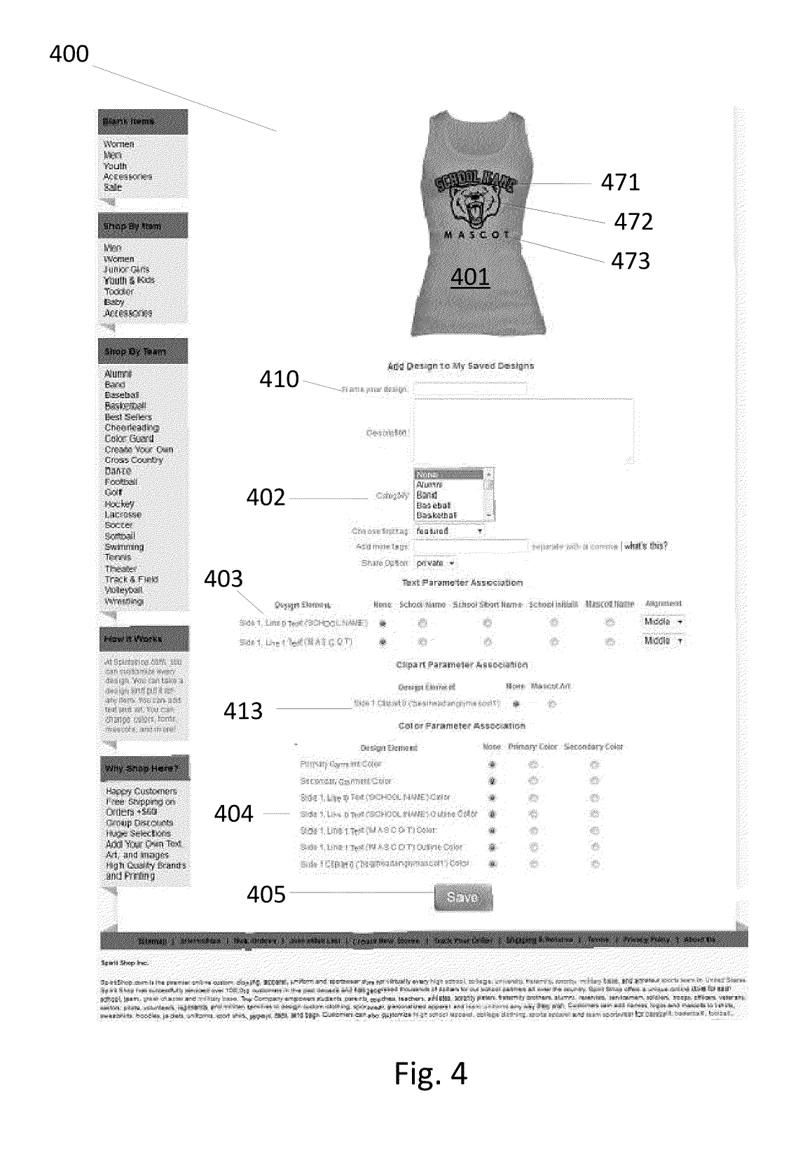

FIG. 3 is a screen shot of an interface 300 for creating a template design 340 in accordance with one embodiment. A user may access interface 300 by using a web browser. FIG. 3, and the screen shots of FIGS. 4 and 6-9 below, can be generated by module 16 of FIG. 1. Further, the functionality described in FIGS. 4-9 may be provided by system 10. Interface 300 may provide a design center application to the user for creating the template design 340 from which other customized designs may be generated.

In one embodiment, the design center application is an application configured for use on mobile devices. This design center application for mobile devices may be written in HTML5, for example. In one embodiment, the design center application will first detect whether or not the user is using a mobile browser. If the user is using a mobile browser, the design center application will automatically appear as a mobile version of the design center application. The mobile version is similar to the desktop version, but the mobile version does not have an upload image tab 324 or name/number tab 323. The mobile version also relies on bounding boxes around design objects. Bounding boxes around design objects are used because a user may choose an object in order to adjust the size. The sizing controls are in the same place for all objects. The bounding boxes may highlight currently selected design objects. When an object (e.g., a line of text or a piece of art) is highlighted, the user may easily see which object is selected. A sizing tool (e.g., a tool using an “up” arrow and a “down” arrow) may then be used to change the size of the selected object. Bounding boxes may not be needed for a non-mobile design center because individual size controls may be next to each element on a side of the non-mobile design center. However, because a mobile design center may have one set of size controls, the selected object to be made larger or smaller may need to be highlighted. If a user is viewing the desktop version of the design center application, the user can switch to the mobile version of the design center application by clicking a text link at the bottom of the page that indicates “click here for mobile version.”

The design center application enables creation of a template design 340 for retail items by, for example, a user. The template design 340 may also be created by an automated system. The template design 340 may be applied to different categories of retail items 320 (e.g., retail items for men, retail items for women, retail items for junior girls, retail items for youth & kids, retail items for toddlers, retail items for babies, and accessories). In certain embodiments, the design center application may allow customizing of designs for both a front side and a back side of retail items by using tabs 301 and 302, respectively. The design center may also provide additional tabs to allow adding text (tab 326), adding art from an available selection of art (tab 325), uploading of other images to be used (tab 324), and adding a name/number designation (tab 323), for example. The available selection of art may be categorized in accordance to a predetermined set of different categories 306 (e.g., such as “Animals & Mascots”). As many pieces of art may be added as a user prefers. In searching for art within the available selection of art, a search text field 315 or drop-down menus for navigation may be used, for example.

When adding text with the “Add Text” tab 326, characteristics of each line of text may be adjusted. For example, the arch and size of each individual line of text can be adjusted. The size of all lines of text may be adjusted at once. In one embodiment, a default option displays four lines of text and includes a button that may be clicked to add more lines. Text style (or font), color, and outline of the text may be changed. The text may be easily centered by clicking a single button. In another embodiment, if a user wants to add an additional style of text, or multiple colors of text, the user may click on a new “add a new text style” tab within the “Add Text” tab 326. In one embodiment, there may be a total of five individual text style tabs within the main “Add Text” tab 326. Many fonts, including rhinestone fonts, may be chosen.

With regard to creating an outline around text, if the design center application is rendering text using a program like Macromedia Flash™, then an outline around a text object may be rendered by Flash. However, in order to later print the rendered outlined text on retail items, the rendered outlined text may need to be converted into a different image format, such as a jpeg format, for example. In order to perform the conversion process, certain embodiments offset the outlined text in a circular pattern, stamping the shape of the outlined text a plurality of times (e.g., 15 times) around the original position of the outlined text. The non-outlined text color is then overlaid on top of the stamped pattern, creating the effect of text with an outline around it.

The name/number tab 323 allows names and jersey numbers for multiple shirts to be quickly and easily added. This is especially helpful for creating shirts for a sports team. When using the name/number tab 323, a name, a number, and a size may be entered. The text styles and colors may be changed. The size of the text may be adjusted. In one embodiment, when a name is first added, that name will appear in the design center application. The number will appear below the name. When a new name is added, the old name and old number disappear while the new name is typed. As such, suppose a user wishes to use name/number tab 323 to create jerseys for teammates. The name/number tab 323 may allow a user to create jerseys for a team that include up to 99 different name/numbers. A name, number, and size may be entered for each teammate. A uniform template for the jerseys is then created, and each jersey will appear the same in terms of text style, color, and size. In one embodiment, when the user places the order for the jerseys, a unique SVG (scalable vector graphic) is generated for all ten jerseys that will then be used to print designs for each jersey.

The design center application may also include a preview window 304 which allows a created template design 340 to be previewed. For example, referring to template design 340 within preview window 304, template design 340 includes text 351 corresponding to a “school name,” art 352 from the subcategory “bears” of the category “Animals & Mascots,” and additional text 353 corresponding to a “Mascot” name. Template design 340 may also be applied onto a certain category of clothing (i.e., “Junior Fit Basic Bella 2×1 Rib Tank Top,” retail item for women) of a certain item color (i.e., “gray”). In addition to allowing a created template design 340 to be previewed, the design window 304 may also allow distress patterns to be added to portions of the applied design via clicking on a distress design box 344. In one embodiment, the effect of adding a distress pattern is implemented using a graphic pattern saved as a PNG file. This graphic pattern is a mask overlaid on an underlying design. Wherever pixels of the graphic pattern are overlaid on the underlying design, those portions of the underlying image are made invisible, creating a distressed effect for the underlying design.

The design window 304 may also show an available boundary of the possible areas that the design may be printed on a retail item. In one embodiment, the available boundary is a dashed line made up of light gray and dark gray dashes, which allows the boundary to appear on all possible item colors. By viewing the available boundary for which to place a given design, the given design may be more precisely placed on the retail item. After determining the appropriate design and placement for the design for a retail item, a save button 350 can be clicked to specify further characteristics of the design.

FIG. 4 is a screen shot of an interface 400 for configuring elements of a template design 401 in accordance with one embodiment. In one embodiment, after save button 350 of FIG. 3 is clicked, an interface 400 enables further configuring of elements of the created template design 401. For example, interface 400 may allow a name 410 to be designated for referring to the template design 401. Interface 400 may provide various additional categories 402 for categorizing the template design 401. These additional categories 402 may include different categories of intended recipients of retail items (e.g., a recipient of apparel who is an alumni of an educational institution, a recipient who is associated with a band of an educational institution, a recipient who is associated with a particular sport, etc.).

In certain embodiments, interface 400 allows elements of the template design 401 to be configured as being dynamic elements. Dynamic elements may be color elements, text elements, and image elements, for example. For example, design elements list 403 defines a text design element “Side 1, Line 0 Text (“SCHOOL NAME”)” of template design 401 as a dynamic element. This dynamic text design element “Side 1, Line 0 Text (“SCHOOL NAME”)” may be defined as a “school name,” a “school short name,” “school initials,” or a “mascot name,” for example. This dynamic text design element corresponds to “SCHOOL NAME” text 471. As such, when later dynamically generating customized designs, the “SCHOOL NAME” text 471 as currently shown by template design 401 may be later modified/replaced by a later-defined “school name,” “school short name,” “school initials,” or “mascot name” value, for example. Each dynamic element may also be aligned according to a user's preferences.

Interface 400 also allows an art element 472 of template design 401 to be defined as a dynamic element. For example, design elements list 413 defines clip art design element “Side 1 Clipart 0 (“bearheadangrymascot1”)” of template design 401 as a dynamic element. This dynamic element “Side 1Clipart0 (“bearheadangrymascot1”)” may be defined as a later-defined “mascot art” value, for example. As such, the clip art 472 as currently shown by template design 401 may be later modified/replaced by a later defined “mascot art” value, for example.

In certain embodiments, interface 400 allows colors applied to template design 401 to be defined as being dynamic colors. For example, interface 400 provides a list 404 of design elements to be colored. For example, a “primary garment color” may be defined as “none” (i.e., having no dynamically applied color), a “primary color” (i.e., having a dynamically applied color that corresponds to a “primary color” value), and a “secondary color” (i.e., having a dynamically applied color that corresponds to a “secondary color” value). Each retail item may have portions that are colored differently depending upon the dynamic colors assigned to each portion. List 404 may also include other elements to be dynamically colored, such as a secondary garment color, a text color, a text outline color, and a clip art color, for example. After a satisfactory choice of the colors and placement of the dynamic elements of template design 401 is reached, a save icon 405 may be clicked.

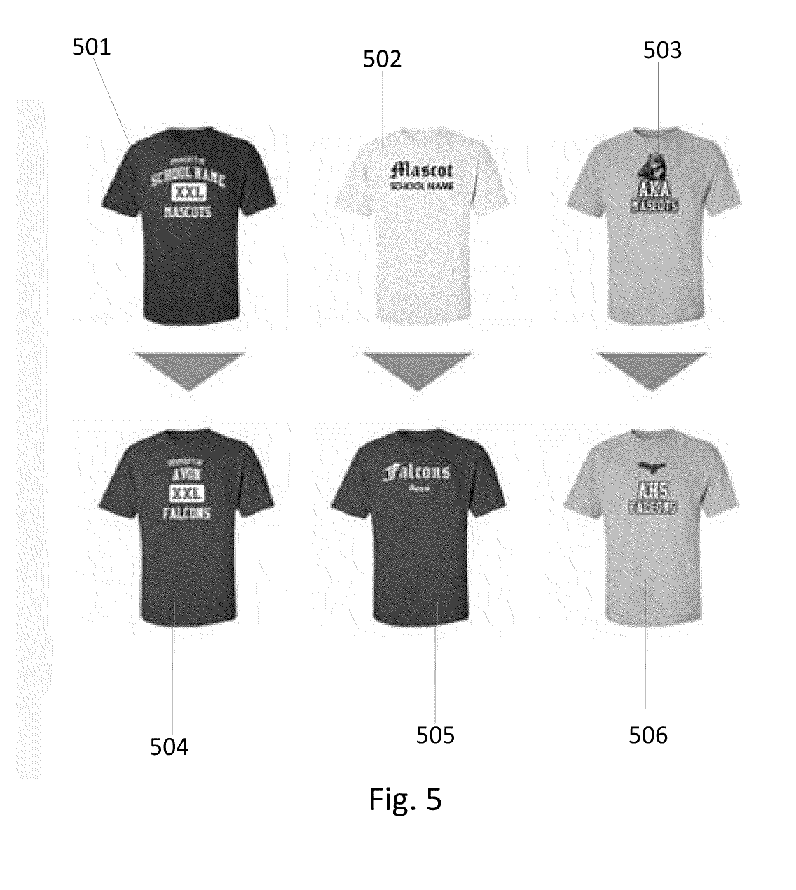

FIG. 5 illustrates examples of retail items (e.g., apparel) with customized designs (504, 505, and 506) based on three different template designs (501, 502, and 503) in accordance with one embodiment. As shown in FIG. 5, template design 501 includes dynamic text “SCHOOL NAME,” dynamic text “MASCOTS,” and a dynamic material (e.g., garment) color. As such, customized retail item 504 based on template design 501 includes text “AVON” (i.e., a city name replacing dynamic text “SCHOOL NAME”) and text “FALCONS” modifying/replacing dynamic text “MASCOTS.” Customized retail item 504 also has a dynamically generated color that replaces the color of template design 501. The dynamic elements and colors are modified/replaced in accordance with the particular provided configuration via interface 400 of FIG. 4, for example.

As shown in FIG. 5, template design 502 includes dynamic text “Mascot,” dynamic text “SCHOOL NAME,” and a dynamic material (e.g., garment) color. As such, customized retail item 505 based on template design 502 includes text “Falcons” (i.e., a mascot name replacing dynamic text “Mascot”) and text “Avon” modifying/replacing dynamic text “SCHOOL NAME.” Customized retail item 505 also has a dynamically generated color that replaces the color of template design 502.

As shown in FIG. 5, template design 503 includes dynamic clip art, dynamic text “AKA,” and dynamic text “MASCOTS.” As such, customized retail item 506 based on template design 503 includes a falcon clip art (a clip art replacing the dynamic clip art of template design 503) and text “AHS” modifying/replacing dynamic text “AKA.” As many template designs may be created as a user desires, and a plurality of customized designs may be generated based on each created template design. A user may then browse through these customized designs.

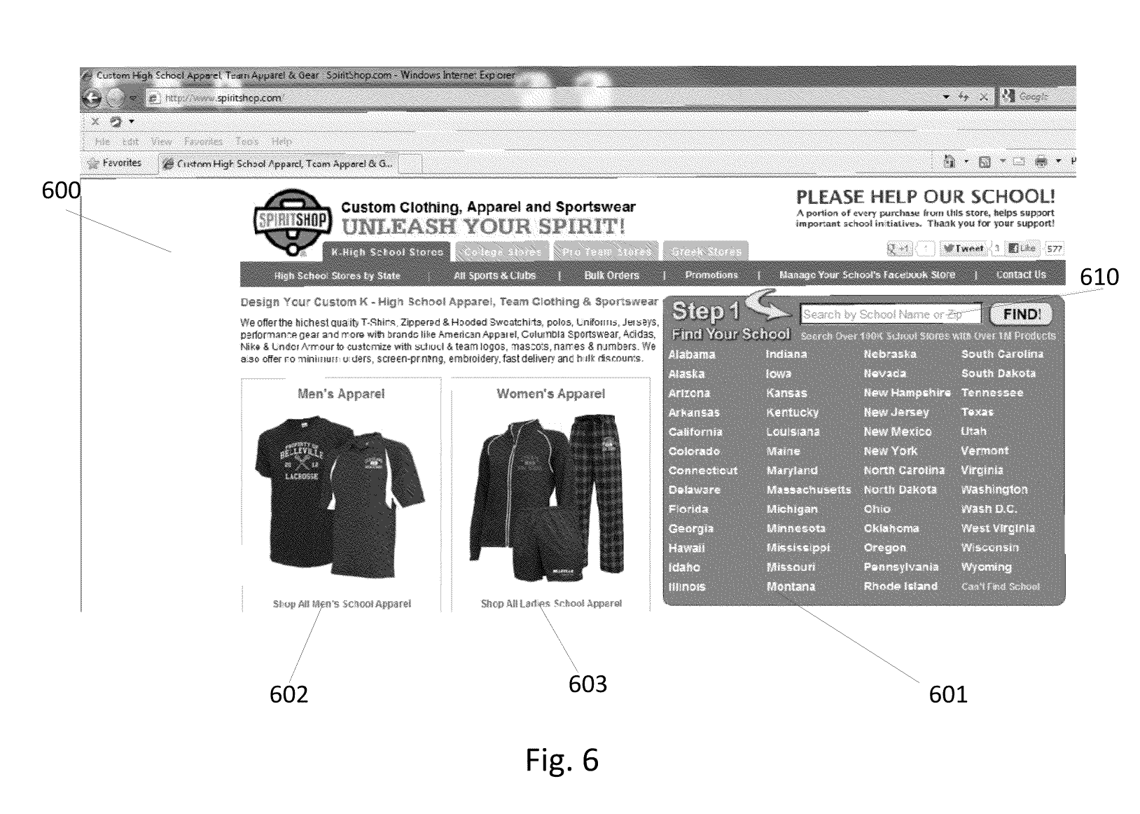

FIG. 6 is a screen shot of an interface 600 for entering information to receive retail items with customized designs in accordance with one embodiment. An entity, such as a user, may choose to receive customized designs as applied to men's retail items by clicking on link 602. The receiving of customized designs may also be chosen by an automated system. A user may choose to receive customized designs as applied to women's retail items by clicking on link 603. FIG. 6 also provides a list 601 of possible selections (e.g., possible states that may be selected) which provide information for dynamically generating the customized designs. The user may also choose to enter information manually (e.g., manually enter a school name or a zip code), into a text box 610, that may be used to dynamically generate customized designs for the user.

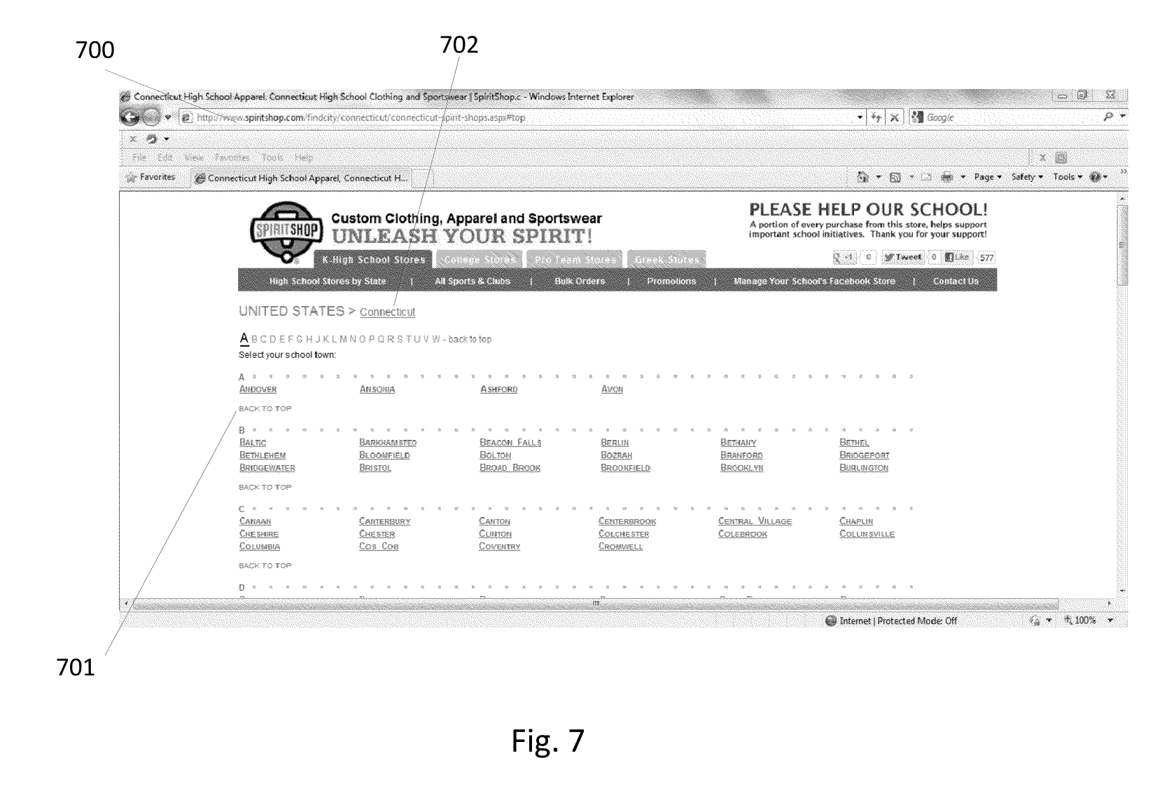

FIG. 7 is a screen shot of an interface 700 for specifying how to dynamically generate customized designs for retail items in accordance with one embodiment. As illustrated in FIG. 7, interface 700 may provide a list of cities 701 associated with a previously-selected state 702 (i.e., “Connecticut”); this interface 700 can be used to enter additional information.

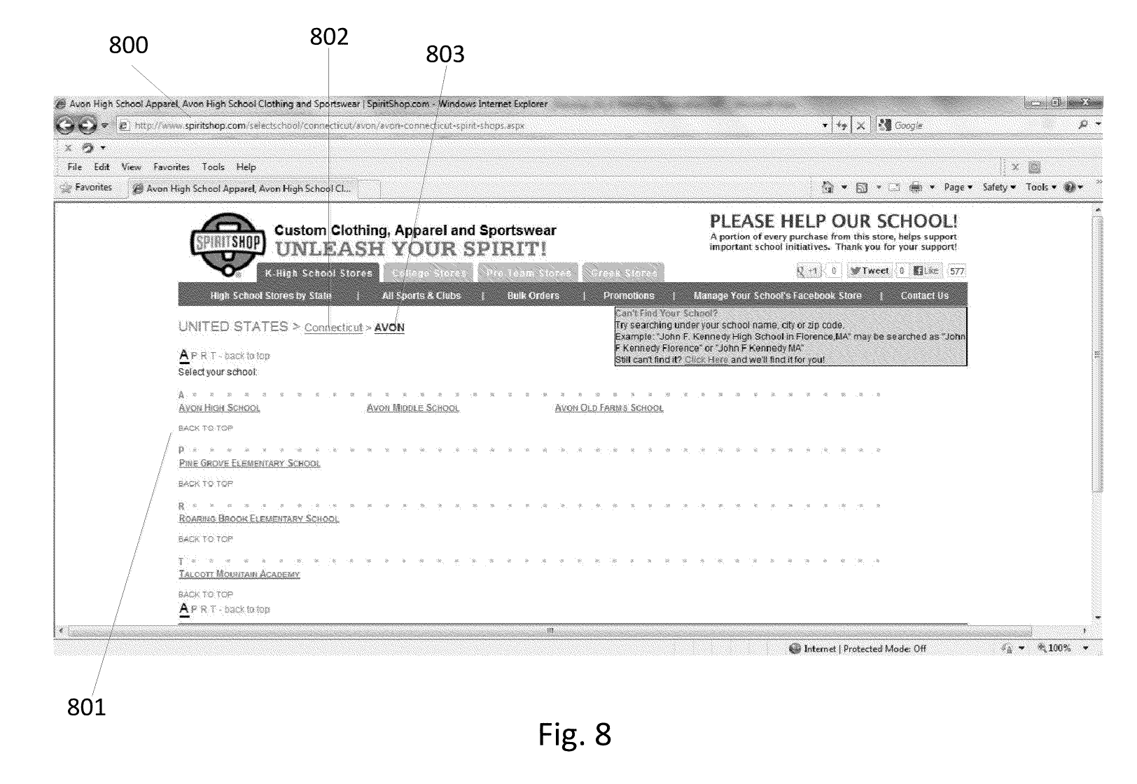

FIG. 8 is a screen shot of an interface 800 for further specifying how to dynamically generate customized designs for retail items in accordance with one embodiment. As illustrated in FIG. 8, interface 800 may provide a list of schools 801 that are present with a previously-selected city 803 (i.e., “AVON”) of a previously selected state 802 (i.e., “Connecticut”).

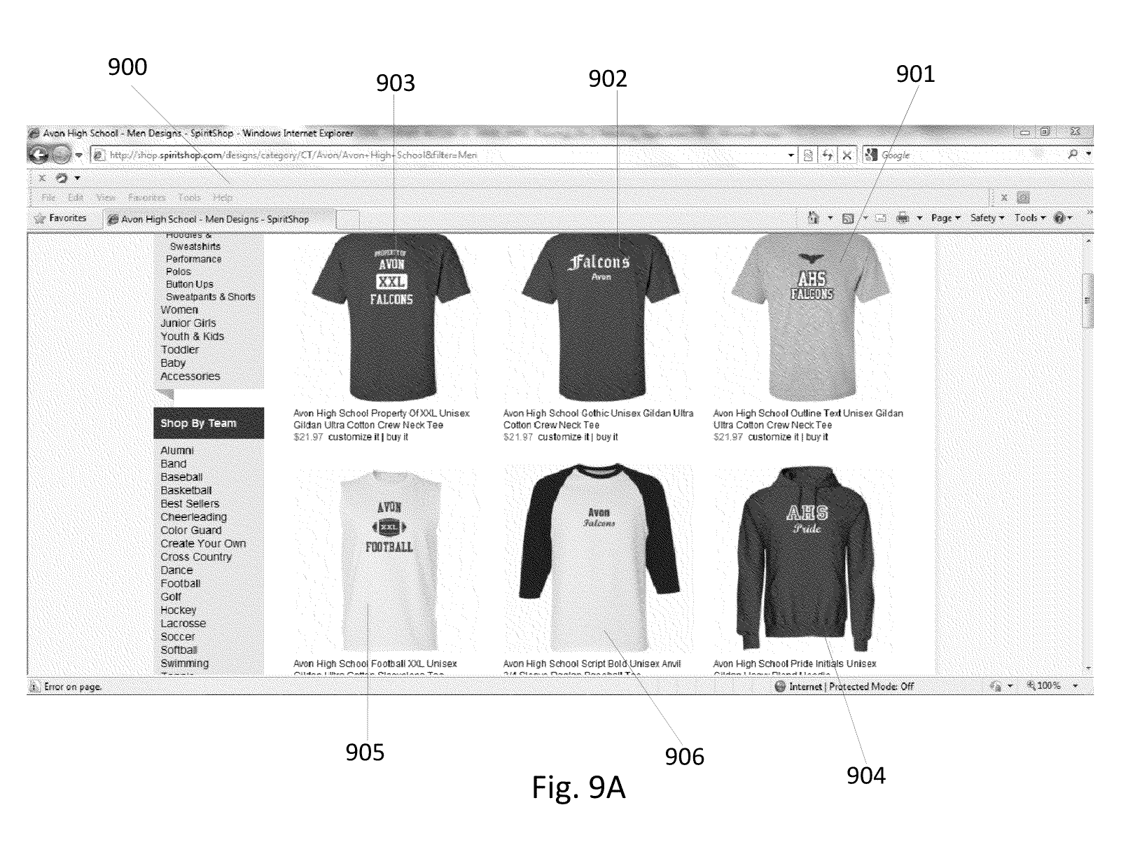

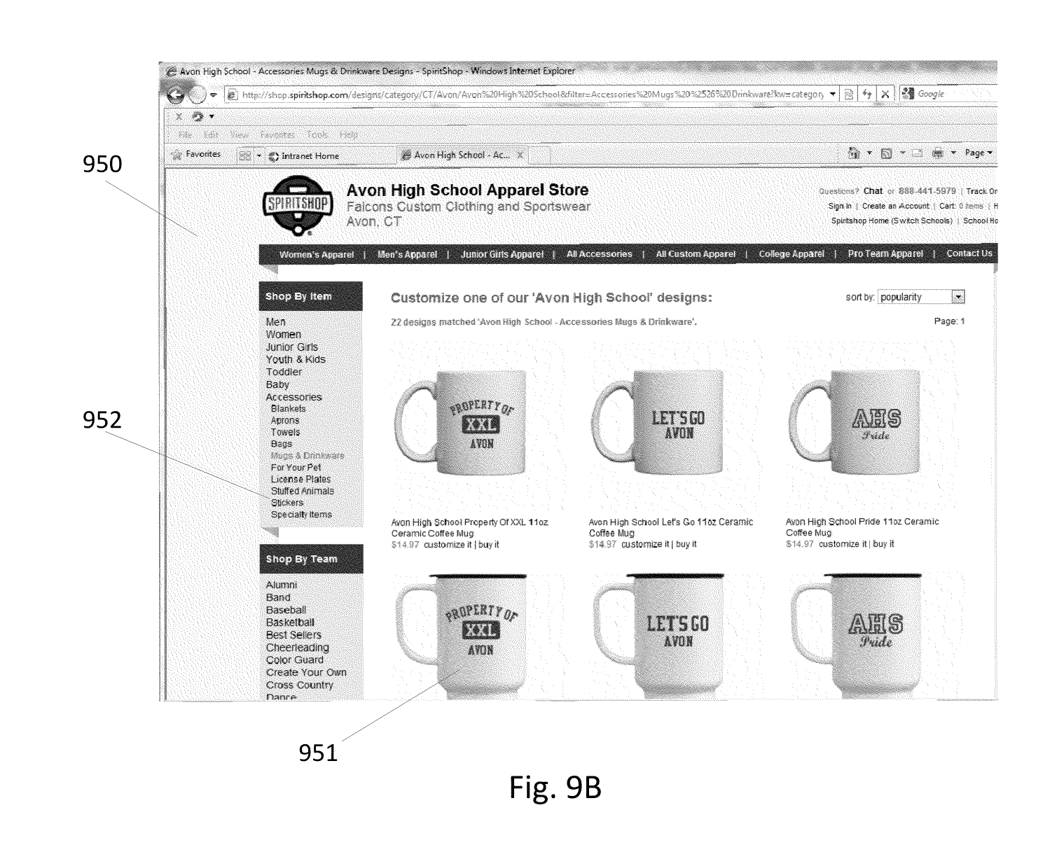

FIG. 9A is a screen shot of an interface 900 for receiving customized designs for retail items (901-906) based upon provided information in accordance with one embodiment. As previously described, each customized design (901-906) may be based on a created template design. The dynamic elements of each customized design (901-906) may be defined in accordance with the information provided by the user.

In the example shown in FIG. 9A, an entity, such as a user, has provided information corresponding to a state (i.e., “Connecticut”), a city (i.e., “AVON”), and a school (i.e., “Avon High School”). As such, each template design would then modify/replace their dynamic elements in accordance with such provided information in order to generate customized designs (901-906).

In customized design 903, (1) “AVON” text has replaced a “school name” dynamic text element, (2) “FALCONS” text has replaced a “mascot name” dynamic text element, and (3) the color blue has replaced the dynamic material color element. The color blue is determined in accordance with the information provided by the user (e.g., the color blue may be a school color of “Avon High School”).

In customized design 902, (1) “FALCONS” text has also replaced a “mascot name” dynamic text, and (2) “AVON” text has also replaced a “school name” dynamic text element, and (3) the color blue has also replaced the dynamic material color element. However, customized design 902 is clearly different than customized design 903. The two customized designs are different because the template design from which customized design 902 is generated is different than the template design from which customized design 903 is generated. As such, customized design 902 is different than customized design 903, despite the fact that both customized designs are generated in accordance with the same provided information.

In customized design 901, a “falcon” clip art has replaced a dynamic clip art element. The “falcon” clip art is associated with the provided information (e.g., the falcon may be the school mascot of “Avon High School.”). Customized designs 904-906 are each applied to different categories of retail items (i.e., apparel with a hood, apparel with colored sleeves, and apparel without sleeves).

In the example illustrated by FIG. 9A, the school colors, the school name, and the school mascot corresponding to “Avon High School” are dynamically applied to the provided retail items. Certain embodiments may dynamically apply appropriate text, images, and colors by referring to a set of stored information for each school. For example, database 17 of FIG. 1 may store the school colors, school name, and school mascot of each school. In the event of a request for customized designs for a particular school whose information is missing/incomplete within the database (e.g., the database has not stored the particular school's mascot, for example), a generic placeholder element may be applied to the retail item as a substitute for an element that corresponds to the missing/incomplete information. For example, a generic graphic may be used in place of a missing/incomplete mascot graphic.

With specific regard to applying colors to retail items, certain embodiments dynamically apply a particular school's set of colors (e.g., typically a primary school color and a secondary school color) to retail items by performing a matching process between the school's set of colors and available material/print colors that can be applied to retail items. As described above, certain embodiments perform the matching by referring to a set of stored colors for the schools. The colors may be stored within database 17 of FIG. 1, for example. Each color may be defined by a red/green/blue (“RGB”) value.

However, when matching a specific school color (i.e., a “target color”) to the available material/print colors, the available material/print colors may not exactly match the specific school color. The material may be a garment. As such, certain embodiments provide a method of selecting a color from the available material/print colors that matches the target color as closely as possible. If none of the available colors is a close enough match, certain embodiments may determine when to use a neutral default color instead of attempting to match the specific target color.

In one embodiment, a color matching algorithm converts the specific target color (the color to be matched) from RGB values (where each of R, G, and B are red/green/blue values ranging from 0 to 255) to target hue/luma/chroma values.

With regard to target hue:

If [max(R,G,B)−min(R,G,B)]=0, then TargetHue=−−1;

If R=max(R,G,B), then TargetHue=(G−B)/[max(R,G,B)−min(R,G,B)];

If G=max(R,G,B), then TargetHue=2+(B−R)/[max(R,G,B)−min(R,G,B)];

and, in all other cases, TargetHue=4+(R−G)/[max(R,G,B)−min(R,G,B)];

Next, with regard to target luma:

TargetLuma=0.3×(R/255)+0.59×(G/255)+0.11×(B/255);

Next, with regard to target chroma:

TargetChroma=[max(R,G,B)−min(R,G,B)]/255

If TargetHue is not determined to be “−1,” then TargetHue will be a calculated value between 0 and 6. This TargetHue value is then multiplied by 60. If the resulting value is less than 0, then 360 is added to the result to yield a final hue value from 0-360 degrees. TargetLuma returns a value ranging from 0-1 (inclusive), and TargetChroma also returns a value ranging from 0-1 (inclusive).

In addition to calculating TargetHue, TargetLuma, and TargetChroma values, specific weight and threshold values that will be used in the algorithm are also calculated. The values and formulas for these weights and thresholds are as follows:

With regard to ChromaThreshold,

ChromaThreshold=0.60;

With regard to HueThreshold,

If (35−|TargetHue−120|)<15, then HueThreshold=15/180;
Otherwise, in all other cases,

HueThreshold=(35−|TargetHue−120|)/180;

With regard to HueWeight,

If TargetChroma>0.9, HueWeight=0.9;
Otherwise, in all other cases, HueWeight=TargetChroma;

With regard to BrightnessWeight,

BrightnessWeight=(1−HueWeight)/2;

With regard to ChromaWeight,

ChromaWeight=(1−HueWeight)/2;

The above weight values are used in the algorithm, described in more detail below, to determine the importance attributed to hue, chroma, and luma values when evaluating available colors (i.e., candidate colors) as possible matches. The importance of Hue is weighted proportionally to the amount of chromacity in the target color. Brightness (luma) and chroma may be weighted the same, and the sum of the hue, luma, and chroma weights, in this example, can add up to 1.0. As such, highly chromatic (i.e., heavily saturated) target colors will be compared with candidate colors by using a criteria that places heavy emphasis on how similar the hues are. Moderately chromatic target colors will be compared with candidate colors by using a criteria that places relatively even emphasis on how close in hue, brightness, and chromacity they are. Extremely unchromatic (i.e., heavily desaturated) target colors will be compared with candidate colors by using a criteria that places heavy emphasis on how close in brightness and chromacity they are.

The threshold values, on the other hand, are used, as described in more detail below, to replace a best matching color (as determined by calculations of the algorithm) with a default color (i.e., not use the determined “best matching color”) if the best matching color is still not close enough to the target color. If the HueThreshold value is calculated in accordance with the above, then a best matching color is allowed to deviate more from a target hue when the target hue is closer to green. The method of computing the ChromaThreshold, as described above, may allow rejection of best matching colors which are similar in hue and brightness to target colors but that have completely different saturation levels from the target colors.

After the weight and threshold values have been calculated, the algorithm then performs comparisons between the target color and each of the candidate colors (hereafter referred to as the “current color”). The algorithm is directed at finding a candidate color that is closest to the target color while also meeting a predetermined threshold.

The algorithm performs a plurality of iterations corresponding to the number of candidate colors to be compared to the target color. For each iteration, the algorithm performs the following steps:

In one step, the algorithm computes the (hue/luma/chroma) value of the current color. This is done using the same formulas as described above, except that the output values will be henceforth referred to as “CurrentHue,” “CurrentLuma,” and “CurrentChroma,” respectively.

In another step, the algorithm computes the HueDistance between the target color and the current color using the following formula:

If |CurrentHue−TargetHue|≧180,

then HueDistance=(360−|CurrentHue−TargetHue|)/180;

Otherwise, in all other cases,

HueDistance=(|CurrentHue−TargetHue|)/180;

In another step, the algorithm computes the ColorDistance between the target color and the current color using the following formula. The ColorDistance is basically a weighted Euclidean distance from the current color to the target color in 3-dimensional hue/chroma/luma space.

ColorDistance=((HueDistance²)×HueWeight+((CurrentLuma−TargetLuma)²)×BrightnessWeight+((CurrentChroma−TargetChroma)²)*ChromaWeight)^{0.5}

In another step, if the current color's ColorDistance value is the lowest color distance value that has been encountered thus far during the interations, then the current color is selected as a new best color match (replacing any previous “current color” that was selected as a best match in a prior iteration). The following values are then saved:

MatchingHueDistance=HueDistance;

MatchingChromaDistance=|CurrentChroma−TargetChroma|;

After the algorithm performs iterations for all of the candidate colors, the best color match is returned if at least one of the following conditions is met:

(MatchingChromaDistance<ChromaThreshold) and (MatchingHueDistance<HueThreshold); Condition 1:

TargetChroma=0; Condition 2:

If neither of the above conditions are met, the algorithm returns a default color, indicating that there was no acceptable matching color among the candidate colors for the target color.

As such, certain embodiments provide an algorithm that eliminates certain otherwise matching candidate colors in order to avoid using candidate colors that are mathematically “close” to target colors, but which are nevertheless not perceptually close enough to the target colors. In the one exception when “TargetChroma=0,” the algorithm would not eliminate candidate colors because there would be no need to eliminate candidate colors based on hue or chroma distance. In such a case, there would be no need to eliminate candidate colors based on hue or chroma distance because, when “TargetChroma=0,” the target color has no hue or chromacity (i.e., the target color is gray or black, for example). The color provided by the algorithm (whether it be a matching color or a default color) may then be dynamically applied to the retail items.

As such, certain embodiments provide retail items with dynamically applied colors that represent a school's color to a relatively close degree of accuracy. If such accuracy cannot be obtained with the available colors, then a neutral default color (such as gray or white) may be used instead. Although certain embodiments use the above algorithm to match candidate colors with target colors that correspond to school colors, other embodiments may match candidate colors with target colors that correspond to colors associated with other types of entities (e.g., company, city, country, group association).

As described above, certain embodiments allow for receiving customized designs for retail items without requiring a user to directly specify how the designs are to be customized. For example, as described above, in certain embodiments, a user may provide information specifying a specific school, without specifying any school colors, any school mascot, or any school name. Although the user has only specified a specific school, certain embodiments will automatically determine how to customize designs for retail items (using appropriate school colors, an appropriate school mascot, etc.). Although FIG. 9A shows designs based upon a specified school, in other embodiments, an entity, such as a user, may specify any other type of entity (e.g., company, city, country, group association) that has a name, associated color, and/or an associated mascot to receive customized retail items directed to an entity other than a school. The specific parameters used for customizing designs for retail items may be derived from the provided information, as opposed to being directly provided. Further, in certain embodiments, the customized designs for retail items are presented in a manner such that a user is unaware that the customized designs for retail items are dynamically generated. When the customized designs for retail items are transmitted to the user, the transmitting may be performed without communicating to the user that the customized designs were dynamically generated after the provided information was received.

FIG. 9B is a screen shot of an interface 950 for receiving customized designs for additional retail items based upon provided information in accordance with one embodiment. Certain embodiments may generate customized designs for retail items that are not apparel items. For example, a customized design may be generated for retail item 951 that is a mug. Different categories of retail items 952 may include blankets, aprons, towels, bags, mugs & drinkware, items for pets, license plates, stuffed animals, stickers, and specialty items, for example.

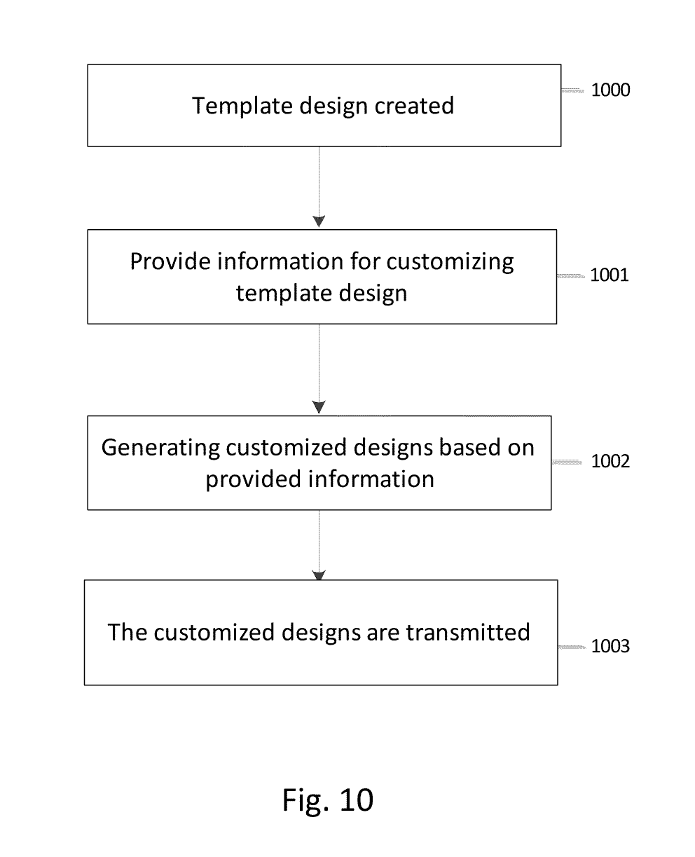

FIG. 10 is a flow diagram of the functionality of the customized design generating module 16 of FIG. 1 in accordance with one embodiment. In one embodiment, the functionality of the flow diagram of FIG. 10 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 1000, a template design is created including at least one dynamic element. As previously described, the template design may be created via various interfaces (e.g. interfaces 300 and 400 of FIGS. 3 and 4, respectively).

At 1001, information for customizing at least one created template design may be provided. For example, as previously described, information relating to a particular high school may be provided by, for example, a user via interfaces 600, 700, and 800 of FIGS. 6, 7, and 8, respectively. In addition to providing the information by a user, other embodiments may provide the information by using an automated system.

At 1002, customized designs are generated based on the provided information.

At 1003, the customized designs are transmitted. For example, customized designs may be transmitted to a user via interface 900 of FIG. 9.

As described above, certain embodiments are directed to a system for generating customized designs for retail items. The system dynamically generates customized designs for retail items based upon a template design and provided information. As such, because thousands of customized designs may be generated from each template design, certain embodiments provide users with a wider selection of customized designs for retail items. Although thousands of customized designs may be generated from each template design, in certain embodiments, the images corresponding to these customized designs are dynamically generated only after the information for generating the designs is provided.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer program embodied on a non-transitory computer readable medium, said computer readable medium having instructions stored thereon that, when executed by a computer, cause the computer to perform:
receiving information specifying an entity;
generating at least one customized design for a retail item based on a template design and the received information, wherein the template design comprises at least one element that is configured to be modified based on the received information, and the at least one element is one of a text object, image object, or color that is modified to correspond to text, an image, or a color associated with the specified entity; and
transmitting the at least one customized design.

2. The computer program of claim 1, wherein the receiving information comprises receiving information specifying a school.

3. The computer program of claim 1, wherein the generating at least one customized design comprises dynamically generating the at least one customized design after the information specifying the entity is received.

4. The computer program of claim 1, wherein the generating at least one customized design comprises:
calculating Euclidean color-distance values in a three-dimensional hue/chroma/luma space between colors of a set of candidate colors and a color associated with the specified entity, wherein the set of candidate colors comprises available material or print colors;
defining one of the candidate colors as a best color match, wherein the best color match has the smallest color-distance value to the color associated with the specified entity among the set of candidate colors; and
modifying the at least one element to correspond to the best color match.

5. The computer program of claim 1, wherein the generating at least one customized design comprises:
calculating Euclidean color-distance values in a three-dimensional hue/chroma/luma space between colors of a set of candidate colors and a color associated with the specified entity, wherein the set of candidate colors comprises available material or print colors;
defining one of the candidate colors as a best color match, wherein the best color match has the smallest color-distance value to the color associated with the specified entity among the set of candidate colors;
determining a default color, wherein the default color comprises a neutral color; and
modifying the at least one element to correspond to one of the best color match or the default color, wherein the at least one element is modified to correspond to the default color if the best color match does not meet chroma and hue thresholds.

6. The computer program of claim 3, wherein the transmitting is performed without communicating to a user that the at least one customized design was dynamically generated after the information specifying the entity was received.

7. A method comprising:
receiving information specifying an entity;
generating at least one customized design for a retail item based on a template design and the received information, wherein the template design comprises at least one element that is configured to be modified based on the received information, and the at least one element is one of a text object, image object, or color that is modified to correspond to text, an image, or a color associated with the specified entity; and
transmitting the at least one customized design.

8. The method of claim 7, wherein the receiving information comprises receiving information specifying a school.

9. The method of claim 7, wherein the generating at least one customized design comprises dynamically generating the at least one customized design after the information specifying the entity is received.

10. The method of claim 7, wherein the generating at least one customized design comprises:
calculating Euclidean color-distance values in a three-dimensional hue/chroma/luma space between colors of a set of candidate colors and a color associated with the specified entity, wherein the set of candidate colors comprises available material or print colors;
defining one of the candidate colors as a best color match, wherein the best color match has the smallest color-distance value to the color associated with the specified entity among the set of candidate colors; and
modifying the at least one element to correspond to the best color match.

11. The method of claim 7, wherein the generating at least one customized design comprises:
calculating Euclidean color-distance values in a three-dimensional hue/chroma/luma space between colors of a set of candidate colors and a color associated with the specified entity, wherein the set of candidate colors comprises available material or print colors;
defining one of the candidate colors as a best color match, wherein the best color match has the smallest color-distance value to the color associated with the specified entity among the set of candidate colors;
determining a default color, wherein the default color comprises a neutral color; and
modifying the at least one element to correspond to one of the best color match or the default color, wherein the at least one element is modified to correspond to the default color if the best color match does not meet chroma and hue thresholds.

12. The method of claim 9, wherein the transmitting is performed without communicating to a user that the at least one customized design was dynamically generated after the information specifying the entity was received.

13. A system comprising:
a processor;
a memory coupled to the processor;
a receiving module configured to receive information specifying an entity;
a generating module configured to generate at least one customized design for a retail item based on a template design and the received information, wherein the template design comprises at least one element that is configured to be modified based on the received information, and the at least one element is one of a text object, image object, or color that is modified to correspond to text, an image, or a color associated with the specified entity; and
a transmitting module configured to transmit the at least one customized design.

14. The system of claim 13, wherein the receiving module is configured to receive information specifying a school.

15. The system of claim 13, wherein the generating module is configured to dynamically generate the at least one customized design after the information specifying the entity is received.

16. The system of claim 13, wherein the generating module comprises:
a calculating module configured to calculate Euclidean color-distance values in a three-dimensional hue/chroma/luma space between colors of a set of candidate colors and a color associated with the specified entity, wherein the set of candidate colors comprises available material or print colors;
a defining module configured to define one of the candidate colors as a best color match, wherein the best color match has the smallest color-distance value to the color associated with the specified entity among the set of candidate colors; and
a modifying module configured to modify the at least one element to correspond to the best color match.

17. The system of claim 13, wherein the generating module comprises:
a calculating module configured to calculate Euclidean color-distance values in a three-dimensional hue/chroma/luma space between colors of a set of candidate colors and a color associated with the specified entity, wherein the set of candidate colors comprises available material or print colors;
a defining module configured to define one of the candidate colors as a best color match, wherein the best color match has the smallest color-distance value to the color associated with the specified entity among the set of candidate colors;
a determining module configured to determine a default color, wherein the default color comprises a neutral color; and
a modifying module configured to modify the at least one element to correspond to one of the best color match or the default color, wherein the at least one element is modified to correspond to the default color if the best color match does not meet chroma and hue thresholds.

18. The system of claim 15, wherein the transmitting module is configured to transmit without communicating to a user that the at least one customized design was dynamically generated after the information specifying the entity was received.
